(19) United States
(12) Patent Application Publication
(10) Pub. No.: US 2019/0220185 A1
(43) Pub. Date: Jul. 18, 2019

(54) IMAGE MEASUREMENT APPARATUS AND COMPUTER READABLE MEDIUM

(71) Applicant: Mitutoyo Corporation, Kawasaki (JP)

(72) Inventors: Gyokubu Cho, Kanagawa (JP); Koichi Komatsu, Kanagawa (JP); Yasuhiro Takahama, Kanagawa (JP); Hiraku Ishiyama, Kanagawa (JP); Barry Saylor, Kirkland, WA (US); Dahai Yu, Kirkland, WA (US); Ryan Northrup, Kirkland, WA (US)

(21) Appl. No.: 16/243,784

(22) Filed: Jan. 9, 2019

Related U.S. Application Data
(60) Provisional application No. 62/616,570, filed on Jan. 12, 2018.

(51) Int. Cl. G06F 3/0488; G06F 3/0484

(52) U.S. Cl. CPC G06F 3/04883; G06F 2203/04808; G06F 3/0484

(57) ABSTRACT

The present invention relates to an image measurement apparatus images an object to be measured, and measures dimensions and shape of the object to be measured based on an image of the object to be measured displayed on the touch-sensitive panel display. The apparatus comprising: an controller that identifies a command corresponding to a gesture contact-input with respect to the touch-sensitive panel display from a signal output from the touch-sensitive panel display in response to the gesture, and executes the command with respect to a part in the image measurement apparatus, the part being the target of the execution of such command. The gesture is a gesture performed in the state in which the simultaneous touch is made at two or more points.

### CROSS-REFERENCE TO RELATED APPLICATION

This non-provisional application claims benefit pursuant to 35 U.S.C. § 119(e) of U.S. provisional patent application 62/616,570, filed Jan. 12, 2018, the entire contents of which are incorporated herein by reference.

### BACKGROUND

### Technical Field

The present invention relates to a user interface using a touch-sensitive panel display of a measurement device.

### Background Art

Image measurement apparatuses are used as measurement devices that measure and assess the dimensions and shape of objects to be measured (hereinafter, “workpieces”) by making use of images obtained by imaging the workpieces. The image measurement apparatuses acquire edge information (position coordinates, etc.) of the figure to be measured contained in the imaged workpiece image and perform assessment of the shape and dimensions of the workpieces based on the edge information.

With the recent popularization of touch-sensitive panel displays, so-called touch-sensitive interfaces are becoming widely used as intuitively easy-to-use user interfaces that can be operated by touching the displays, etc., and the touch-sensitive interfaces also find application in image measurement apparatuses (see, for example, JP2016-173703A).

However, there are cases where intuitive operations become difficult if the interfaces for operations using a conventional mouse, or the like, are merely directly converted to touch-sensitive interfaces.

### SUMMARY OF THE INVENTION

### Problems to be Solved by the Invention

In view of the problem described above, an object of the present invention is to provide a position specifying method and a program that allow a position to be accurately specified through finger touch input.

### Means for Solving the Problems

To solve the problem described above, an image measurement apparatus images an object to be measured, and measures dimensions and shape of the object to be measured based on an image of the object to be measured displayed on the touch-sensitive panel display. The apparatus comprising: an controller that identifies a command corresponding to a gesture contact-input with respect to the touch-sensitive panel display from a signal output from the touch-sensitive panel display in response to the gesture, and executes the command with respect to a part in the image measurement apparatus, the part being the target of the execution of such command. The gesture is a gesture performed in the state in which the simultaneous touch is made at two or more points.

In the present invention, the command may be a command that causes a physical movement of parts of the image measurement apparatus.

In the present invention, the gesture performed in the state in which the simultaneous touch is made at two or more points may be a tap, a double tap, a long tap, a flick, a swipe, a drag, or a rotation.

A non-transitory computer readable medium storing a program according to the present invention causes a computer to function as the controller of the image measurement apparatus described above.

### BRIEF DESCRIPTION OF THE DRAWINGS

FIG. 1 shows an example of the entire configuration of an image measurement apparatus.

FIG. 2 shows a functional block diagram of a computer system.

FIGS. 3A and 3B show an example of a display screen displayed on a touch-sensitive panel display.

FIG. 4 shows an example of a display screen displayed on the touch-sensitive panel display.

FIG. 5 shows an example in which two fingers are simultaneously making contact with the touch-sensitive panel display 144.

FIG. 6 shows a flowchart of position specification processing.

FIGS. 7A and 7B schematically show the state in which a screen (first window W1) is touched with a finger. A display example of the screen is shown, along with a finger of a user, when the distance from an initial contact position P1 to a contact position CP has reached a predetermined distance.

FIGS. 8A and 8B schematically show the state in which the contact position CP is slightly moved from the initial contact position P1.

FIG. 9 shows a display example of the screen, along with a finger of a user, when the distance from the initial contact position P1 to the contact position CP has reached a predetermined distance.

FIG. 10 shows a display example of the screen, along with a finger of a user, when the contact position CP is further moved from the state in FIG. 9.

FIG. 11 shows a display example of the screen after sensing a position specification determination operation.

FIG. 12 shows an example of a display screen in which a rectangular edge detection tool is displayed in the first window W1 in an editable manner.

FIG. 13 shows an example of a display screen in which a circular edge detection tool is displayed in the first window W1 in an editable manner.

### DETAILED DESCRIPTION OF THE EMBODIMENTS

Hereinafter, embodiments of the present invention will be described based on the drawings. It should be noted that, in the following descriptions, identical members are denoted by identical reference numbers and the description of the members that have already been described before will be omitted when appropriate.

### Configuration of Image Measurement Apparatus

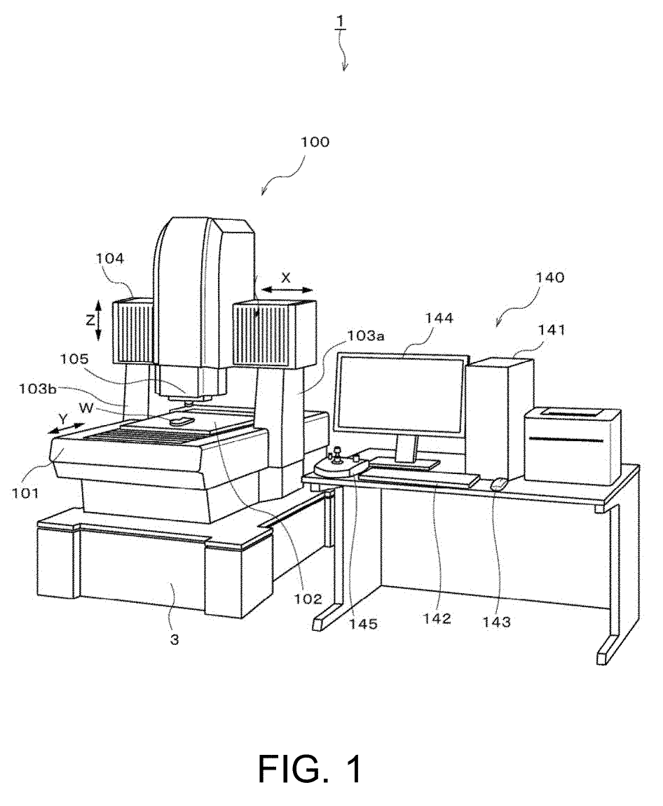

FIG. 1 shows an example of the entire configuration of an image measurement apparatus.

A measurement unit 100 is provided with a mount 101, a sample table (stage) 102, support arms 103a, 103b, an X-axis guide 104 and an imaging unit 105. As shown in FIG. 1, the measurement unit 100 is arranged on an anti-vibration table 3 placed on the floor. The anti-vibration table 3 prevents the vibration of the floor from propagating to a measurement apparatus 1 on the table. The anti-vibration table 3 may be an active type or a passive type. The mount 101 is arranged on a top board of the anti-vibration table 3, and, on top of the mount 101, the stage 102, on which the workpiece W is to be carried, is mounted such that the top surface thereof coincides with a horizontal surface as a base surface. The stage 102 is driven in the Y-axis direction by a Y-axis drive mechanism (not shown) and is enabled to move the workpiece W in the Y-axis direction with respect to the imaging unit. The upwardly extending support arms 103a, 103b are fixed at the center of both side edges of the mount 101. The X-axis guide 104 is fixed so as to couple both of the upper end parts of the support arms 103a, 103b. The X-axis guide 104 supports the imaging unit 105. The imaging unit 105 is driven along the X-axis guide 104 by an X-axis drive mechanism (not shown). The imaging unit 105 is driven along the vertical direction (Z-axis direction) by a Z-axis drive mechanism (not shown).

At a lower end part of the imaging unit 105, an imaging element, such as a CCD camera or the like, is provided so as to face the stage 102. The imaging unit 105 measures the workpiece at a measurement position set by a computer system 2.

The computer system 140 controls the measurement unit 100 to acquire the imaged image of the workpiece W and to provide a user with an operational environment. The computer system 140 is provided, for example, with a computer body 141, a keyboard 142, a mouse 143, a touch-sensitive panel display 144, a joystick 145, and the like. The computer body 141 controls the operation of the measurement unit 100 by means of a circuit (hardware), such as a control board or the like, and a program (application software for measurement) executed by a CPU. The computer body 141 also performs processing of acquiring and calculating the information of the workpiece W based on the signals output from the measurement unit 100 and then, of displaying the calculation result on the touch-sensitive panel display 144. The keyboard 142, the mouse 143 and the joystick 145 are input means for the computer body 141. The touch-sensitive panel display 144 functions not only as display means for displaying the images output by the computer body but also as input means for detecting an operation performed by making contact with the screen and for inputting such operation into the computer body 141. The touch operation performed on a menu or icon displayed on the touch-sensitive panel display 144 is processed, within the computer system 140, by emulating such touch operation as a click operation or the like by a mouse, with respect to the menu or icon. The operation of the image measurement apparatus and the method of implementing a touch-sensitive interface regarding the operation specific to the programs of the image measurement apparatus, such as pasting and editing of an edge detection tool, will be described in detail hereinafter.

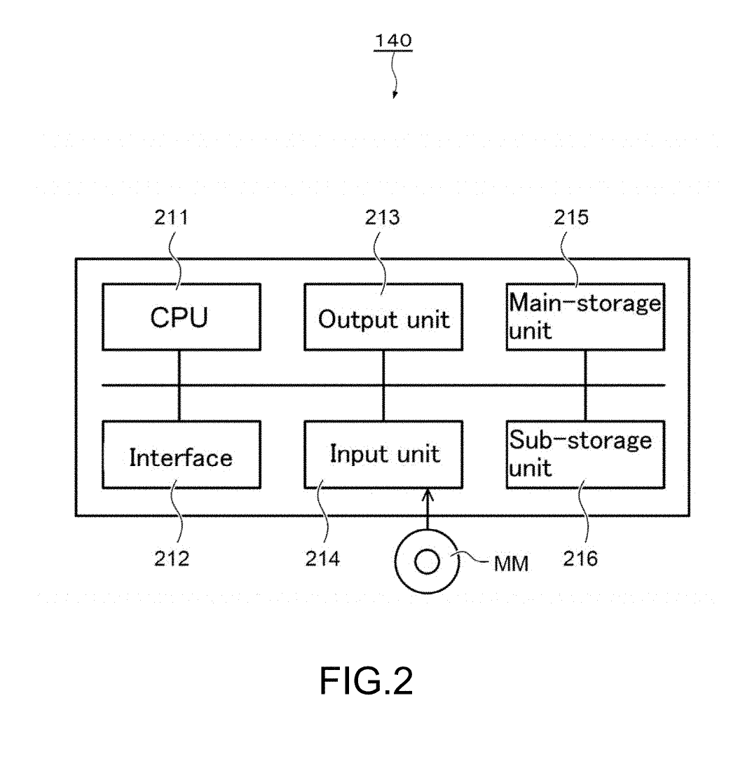

FIG. 2 shows a functional block diagram of the computer system 140. As functional blocks of the computer system 140, a central processing unit (CPU) 211, an interface 212, an output unit 213, an input unit 214, a main storage unit 215 and a sub-storage unit 216 are provided.

The CPU 211 controls the respective units by execution of various programs. The interface 212 plays a role of, for example, taking information sent from the measurement unit 100 in the computer system 140, sending the information from the computer system 140 to the measurement unit 100, connecting the computer system 140 to a local area network (LAN) or a wide area network (WAN), and is a unit that performs information exchange with the exterior devices. It should be noted that, in the present embodiment, the content described as the function of the application software for measurement is achieved by the CPU 211 executing the application software for measurement.

The output unit 213 outputs the result processed by the computer system 140. For the output unit 213, for example, the touch-sensitive panel display 144 shown in FIG. 1, a printer or the like, is used. The input unit 214 receives information from an operator. For the input unit 214, for example, the keyboard 142, the mouse 143, the touch-sensitive panel display 144, the joystick 145 or the like shown in FIG. 1 is used. In addition, the input unit 214 includes a function of reading the information recorded in a memory medium MM.

For the main storage unit 215, for example, a random access memory (RAM) is used. As part of the main storage unit 215, part of the sub-storage unit 216 may be used. For the sub-storage unit 216, for example, a hard disk drive (HDD) or solid state drive (SSD) is used. The sub-storage unit 216 may be an external storage device connected via a network.

### Screen Display

Next, the screen display, which is displayed on the touch-sensitive panel display 144 by means of the program (application software for measurement) executed by the CPU 211 of the computer body 141, will be described.

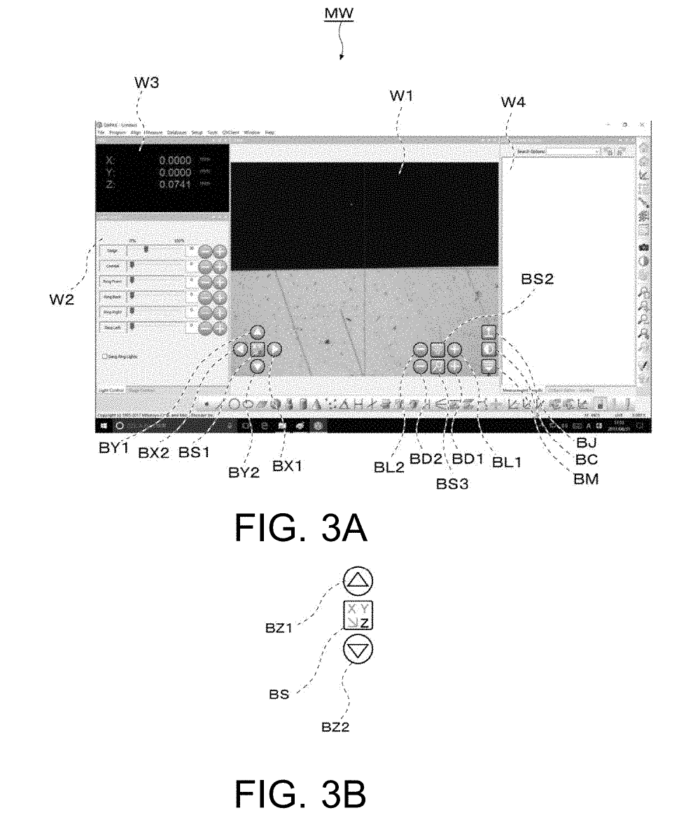

FIG. 3A is a diagram showing an example of the display screen displayed on the touch-sensitive panel display 144 by execution of the application software for measurement. As shown in FIG. 3A, a main window MW is displayed on the touch-sensitive panel display 144. The main window MW displayed on the touch-sensitive panel display 144 can be operated by any of the operation by means of the mouse and the operation by means of a touch input. However, a configuration is also possible in which the operation by means of the mouse and the operation by means of the touch input are distinguishably recognized and different responses may be made between them. For example, a display interval of the menus or icons may be configured such that it is wider when the operation by means of the touch input is received than when the operation by means of the mouse is received. In this way, an interface can be provided in which the possibility of erroneous input by means of the touch input is reduced and in which high-density and efficient display is realized by means of the mouse operation.

A plurality of windows are displayed in the main window MW. A menu bar is displayed on the top side of the main window MW for various operations and settings. In addition, tool bars having icons for various operations and settings arranged therein are displayed on the bottom side and the right side of the main window MW. The tool bars may include icons of the functions selectable by the user, icons of the tools corresponding to methods for specifying a measurement point with in the first window W1, and the like.

The image WG of the workpiece W taken in in the image measurement apparatus 1 is displayed in the first window W1. Considering the operability of the touch-sensitive interface, the first window W1 may be displayed at the center part of the main window MW. The user can zoom the image WG of the workpiece W in/out by, for example, selecting an icon with the mouse 143 or by performing the operation of narrowing or widening (so-called pinching in/pinching out) the interval between the contact positions by means of two fingers with respect to the display region of the first window W1 in the touch-sensitive panel display 144. In addition, the position of the image WG of the workpiece W to be displayed in the first window W1 may be adjusted by the operation of sliding the finger (so-called swiping) while remaining in a condition of contact with the display region of the first window W1 in the touch-sensitive panel display 144.

As shown in FIG. 3A, operation buttons are displayed in the bottom left and bottom right regions of the first window W1 for operating the image measurement apparatus 1 by means of the touch input and the mouse operation.

As for the operation buttons, for example, in the bottom left region of the first window W1, a switching button BS1 for switching the buttons to be displayed in such region is displayed, and operation buttons corresponding to a mode set by the touch input made to the switching button BS1 are displayed around the switching button BS1. For example, the modes may be sequentially switched every time the switching button BS1 is pressed. As for the operation buttons displayed around the switching button BS1, for example, when the switching button BS1 is switched to a mode in which the stage 102 is moved in the X and Y directions, buttons BX1, BX2 for inputting commands to move the stage 102 respectively in the +X direction and the −X direction may be displayed on the right and left sides of the switching button BS1, and buttons BY1, BY2 for inputting commands to move the stage 102 respectively in the +Y direction and the −Y direction may be displayed on the top and bottom sides of the switching button BS1. When the switching button BS1 is switched to a mode in which the stage 102 is moved in the Z-direction relative to the imaging optical system, as shown in FIG. 3B, buttons BZ1, BZ2 for inputting commands to move the stage 102 respectively in the +Z direction and −Z direction may be displayed on the top and bottom sides of the switching button BS1.

Various buttons are also arranged in the bottom right region of the first window W1. For example, buttons BL1, BL2 are buttons for increasing or decreasing the amount of illumination light. A switching button BS2 is provided between the buttons BL1 and BL2. When the switching button BS2 is pressed, a pop-up menu for selecting light sources (vertical illumination, transmitted illumination, ring illumination, and the like), the light amount thereof to be adjusted, is displayed, and the design of the switching button BS2 changes depending on the selection result of the menu, and the types of light sources to be adjusted by the buttons BL1, BL2 are changed. Buttons BD1, BD2 are buttons for increasing or decreasing the display magnification of the image WG displayed in the first window W1. When the buttons BD1, BD2 are pressed, the imaging magnification of the optical system mounted on the imaging unit 105 is changed in a step manner depending on the type of button pressed and the number of button being pressed, and along with this, the display magnification of the workpiece W in the first window W1 is changed. A switching button BS3 is provided between the buttons BD1 and BD2. When the switching buttons BS3 is pressed, a pop-up menu for selecting settable magnifications is displayed and the display magnification is changed to the desired magnification depending on the selection result of the menu. A button BJ is a switching button for deciding which one of the operations is to be made available between the stage control by means of the joystick 145 and the stage control by means of the interface utilizing the touch-sensitive panel display 144 (i.e. various buttons BX1, BX2, BY1, BY2, BZ1, BZ2, or the like, and the gesture). From the viewpoint of preventing erroneous operation by unintentional contact, or the like, only one of the stage control by means of the joystick 145 and the stage control by means of the interface utilizing the touch-sensitive panel display 144 is made exclusively available. A button BC is a button for changing the display state of the images. An example of the display state change performed when the button BC is pressed is the changing of the color of the pixels saturated in the image WG to red in the first window W1 in order to check whether the luminance value of the image is saturated due to the illumination being too bright. A display switching button BM is a button for hiding the display of the buttons in the first window W1.

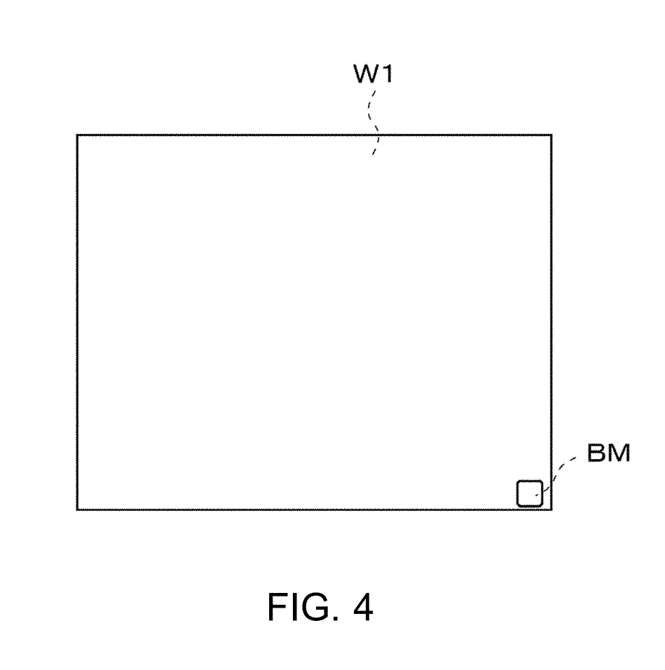

It should be noted that the respective buttons may be displayed at the same time as when the imaged image WG is displayed, or they may not be displayed initially and may be displayed when some input operations are performed by the user. In such case, for example, as shown in FIG. 4, only the display switching buttons BM may be displayed at the same time as when the imaged image WG is displayed, and then, various buttons may be displayed as shown in FIG. 3A when the touch input operation is performed on the display switching buttons BM.

Sliders for controlling illuminations illuminating the workpiece W are displayed in a second window W2 on an illumination-type basis. By operating these sliders, the user can illuminate the workpiece W with the desired illumination. In addition, a tap causes display of the buttons for increasing or decreasing the amount of light on an illumination-type basis.

XY coordinate values of the stage 102 are displayed in a third window W3. The XY coordinate values displayed in the third window W3 are the coordinate in the X-axis direction and the coordinate in the Y-axis direction of the stage 102 with respect to a predetermined point of origin.

A tolerance determination result, measurement result, and the like, are displayed in a fourth window W4 in accordance with the selected measurement method. It should be noted that the diagrammatic representation of the details of the display example of the tolerance determination result and the measurement result are omitted.

It should be noted that, in the example shown in FIG. 3, four windows are displayed in the main window MW; however, the window display of other than four windows is also permitted, if necessary. In addition, it is also permissible to temporarily display a window or tool bar corresponding to a menu in accordance with the selection made from the menus and the like.

The screen layout of the respective windows and tool bars can be changed freely by way of user operation. The screen layout arbitrarily changed by the user may be saved with file names in the main storage unit 215 or the sub-storage unit 216, and may be invoked by selecting the saved screen layout from the menu or the like, to be applied to the main window MW. A standard layout for the touch-sensitive interface may be saved in advance in the main storage unit 215 or the sub-storage unit 216. FIG. 3A is an example of the standard layout for the touch-sensitive interface. The first window W1 displaying the image WG is arranged in the center of the screen and the tool bars, in which icons in sizes enabling easy touch input are arranged, are arranged at the lower part and side part of the screen.

### Operation of Image Measurement Apparatus by Touch-Sensitive Interface

Subsequently, a method for operating the image measurement apparatus 1 by means of the touch-sensitive interface will be described.

The image measurement apparatus 1 according to the present embodiment can be operated by means of a touch input on the buttons displayed in a superimposed manner on the image WG in the first window W1. Each button is allocated with a command (for example, a command for “moving the stage 102 in the +X direction by a predetermined number of steps”) for operating the image measurement apparatus 1. When the touch input operation is performed on a button by the user, the application software for measurement executed by the CPU 211 of the computer body 141 identifies a command corresponding to the operated button from a signal output from the touch-sensitive panel display 144 in response to the touch input operation, and executes such command with respect to a part in the measurement unit 100, the part being the target of the execution of such command.

### Operation of Image Measurement Apparatus by Gesture Input

The image measurement apparatus 1 according to the present embodiment can be operated by means of a gesture which is contact-input with respect to the touch-sensitive panel display 144. More specifically, the application software for measurement executed by the CPU 211 of the computer body 141 identifies a command corresponding to the gesture contact-input with respect to the touch-sensitive panel display 144 from a signal output from the touch-sensitive panel display 144 in response to such gesture, and executes such command with respect to a part in the measurement unit 100, the part being the target of the execution of such command.

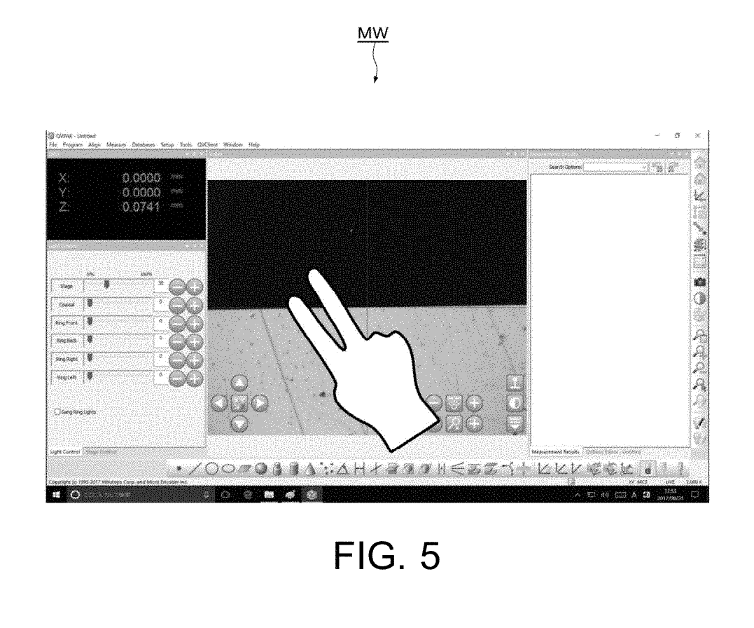

The input gesture is a gesture performed in the state in which the simultaneous touch is made at two or more points (for example, by means of two or more fingers in the case of fingers) on the touch-sensitive panel display 144. Specific examples include a tap, a double tap, a long tap, a flick, a swipe, a drag, a rotation, or the like; however, any other gestures may be used, as long as they are performed with the simultaneous contact at two or more points. FIG. 5 is a diagram showing an example of the state in which the simultaneous contact is made by two fingers with respect to the touch-sensitive panel display 144.

Because the simultaneous contact at two or more points is required, the risk of erroneous operation by a command input arising from the unintentional contact with the touch panel is reduced. Thus, a gesture may correspond to any command; however, it is preferable for the gesture to be applied to a command that requires safety at the time of input. Examples of such command include those for causing a physical movement of parts of the measurement unit 100, such as the X-axis drive mechanism, Y-axis drive mechanism, Z-axis drive mechanism, and the like.

The specific examples of the method of assigning a command to a gesture may include:

(1) Assigning a motor driving command for causing the stage 100 to move in the X-axis or Y-axis direction to a swipe performed in the X-axis or Y-axis direction in the state in which the simultaneous contact is made at two or more points in the imaged image WG of the workpiece W displayed on the touch-sensitive panel display 144;

(2) Assigning a motor driving command for causing the stage 100 to move such that the imaged image WG is displayed at the center of a workpiece window WW to a tap performed in the state in which the simultaneous contact is made at two or more points in the imaged image WG of the workpiece W displayed on the touch-sensitive panel display 144;

(3) Assigning a command for causing an optical system of a housing 110 to perform an auto-focus function to a double tap performed in the state in which the simultaneous contact is made at two or more points in the imaged image WG of the workpiece W displayed on the touch-sensitive panel display 144; and

(4) Assigning a motor driving command for causing the optical system of the housing 110 to move at a low velocity in the Z-axis direction to a rotation performed in the state in which the simultaneous contact is made at two or more points in the imaged image WG of the workpiece W displayed on the touch-sensitive panel display 144.

The above-described correspondence relationship may be stored, for example, in the sub-storage unit 216 and may be referred to at the time of execution of the application software for measurement, or it may be written in the application software for measurement itself.

In addition, not only the above-described aspect where one command is assigned to one gesture is possible but also another aspect is possible where a plurality of motor driving commands for causing the stage 100 to move in the X-axis or Y-axis direction may be combined and executed, thereby moving the stage 100 such that the image WG displayed in the first window W1 is changed by following a drag (the operation of moving along an arbitrary trajectory while maintaining the contact) performed in the state in which the simultaneous contact is made at two or more points in the imaged image WG of the workpiece W displayed on the touch-sensitive panel display 144.

The gesture input made by two fingers to the touch-sensitive panel display 144 may preferably be not accepted if the distance between the two contact positions is larger than a predetermined threshold. For example, when one finger performs a touch input, a separate part of the body or the like, other than such one finger, may also touch the touch-sensitive panel display unintentionally, as a result of which the above may be accepted as a gesture input made by two fingers. However, the above-described erroneous input can be prevented since the above-described configuration is employed and the threshold is set to an approximate interval between the index finger and the middle finger of a person with an average physical size when such fingers are spread out. When a command that requires safety is assigned to a gesture input to be made by two fingers, this is effective in terms of being capable of preventing an unintentional command execution.

The gesture input to be made by two fingers has been mainly described heretofore as an example; however, needless to say, a command may also be assigned to a gesture input to be made by three or more fingers. For example, a command for increasing the illumination may be assigned to an upward swipe (or drag) made by three fingers, and a command for decreasing the illumination may be assigned to a downward swipe (or drag) made by three fingers.

Pasting of Edge Detection Tool with One Click

The application software for measurement applied to the image measurement apparatus 1 according to the present embodiment can apply an edge detection tool (also simply referred to as the “tool”) to the image WG by a single tap operation with respect to the touch-sensitive panel display 144. The edge detection tool acquires edge information (position coordinates, etc.) of the figure to be measured contained in the image WG of the workpiece W displayed in the first window W1. It should be noted that, in the following, applying the edge detection tool to a desired position in the image WG will be referred to as “pasting the tool.”

The application software for measurement makes available, as the edge detection tool, a simple tool that detects an edge corresponding to one point, a circle tool that detects a circular edge, a linear tool that detects a linear edge, or the like. These various tools can be selected by tapping onto icons corresponding to the respective tools in the tool bar.

As a method for pasting the tool to the image WG by means of a touch input, a dragging method and a tapping method are possible. In the dragging method, by performing a drag operation with respect to the first window W1 with the tool to be pasted being selected, the tool can be pasted onto the image WG at the position and with the size and direction, all determined based on the start and end positions of the drag. In this manner, the user can specify the position, size and direction of the tool with the dragging method.

In the tapping method, when the neighborhood of the position in the first window W1, at which the user wants to paste the tool, is tapped with the tool to be pasted being selected, an edge appropriate for the selected tool is searched in the neighborhood of the tapped position, and the tool is automatically pasted at the position and with the size and direction matched to the found edge. It should be noted that when an appropriate edge cannot be found, the tool will be pasted at the tapped position with a predetermined default size and direction.

It should be noted that either the dragging method or the tapping method is automatically applied by the application software for measurement determining the contact operation with respect to the first window W1 is by means of a drag or a tap. It should be further noted that, even when the operation is meant to be made by a tap, there is a possibility that a small tool which is different from what was intended is still pasted when the contact position moves slightly and thus, the operation is treated as a drag operation. In particular, it is often the case that the tapping method is used for the purpose of quickly and sequentially pasting a plurality of tools; however, if an unintentional tool is pasted as described above, the workability will be significantly lost.

In order to solve such inconvenience, even when the contact position of the touch input moves, if the distance moved is equal to or less than a predetermined threshold, the touch input is still considered as a tap and the tool pasting method by means of a tap may be applied. In this case, a small tool having the size equal to or less than the threshold cannot be pasted by means of a drag; however, the size of the tool can be decreased by editing the tool as described hereinafter.

### Position Specification by Touch Input

Detailed position specification in the display screen may be needed when pasting and editing the tools, or the like. In such case, with the conventional input means, such as a mouse, a cursor displayed in the screen is moved using the mouse, etc. and a position may be specified by precisely placing the cursor onto the intended position. In contrast, with the touch-sensitive interface, the center of gravity of the region of a finger or pen tip making contact with the display is normally regarded as being the specified position. The center of gravity of the region making contact with the display is hidden under the finger or pen tip and thus, it cannot be seen by the user. Therefore, the user cannot know precisely the position specified by him/herself and it is not easy to precisely specify an intended position.

Hence, the application software for measurement applied to the image measurement apparatus 1 according to the present embodiment enables a position specification method suitable for the touch-sensitive interface, as will be described hereinafter.

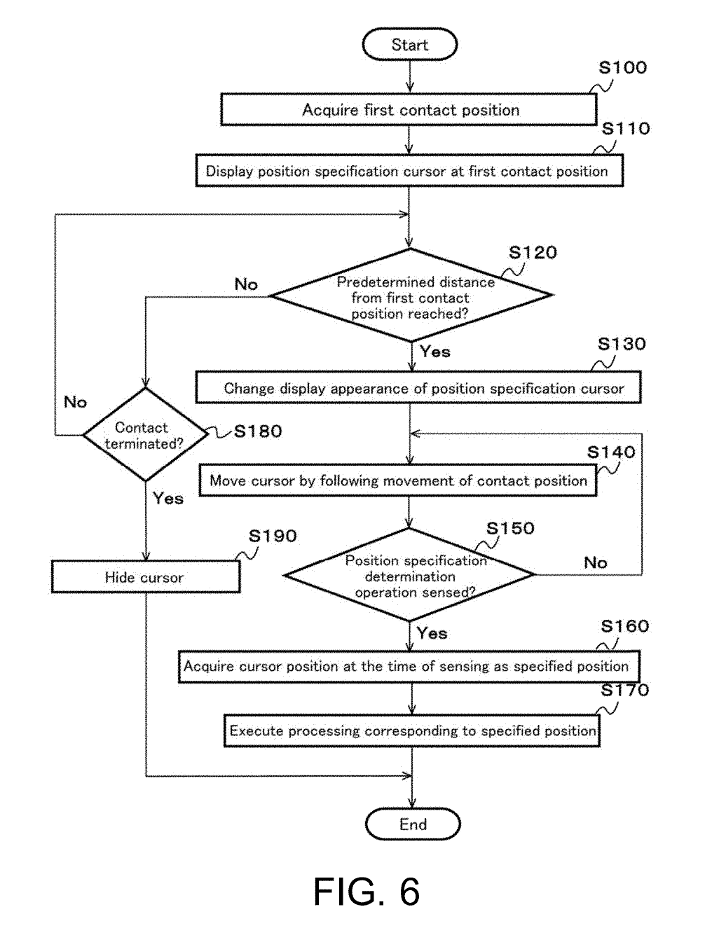

FIG. 6 shows a flowchart of position specification processing implemented with the application software for measurement. The position specification processing starts in response to the touch made in the first window W1 by the user. It should be noted that, once the processing starts, the computer system 140 continuously acquires the contact position and recognizes a sliding operation or a lifting operation.

Once the processing starts, the computer system 140 acquires a position in the first window W1, which is touched by the user for the first time, as a first contact position (step S100), and displays a position specification cursor at the first contact position (step S110).

Subsequently, the computer system 140 determines whether the distance from the first contact position to a contact position has reached a predetermined distance (step S120). If the distance from the first contact position to the contact position has not reached the predetermined distance (step S120; No), the computer system 140 determines whether the contact position can be sensed (namely, whether the contact has been terminated) (step S180). Here, the predetermined distance may be set to a distance such that the first contact position can be sufficiently visually recognized by the user when the finger, pen, or the like, making contact with the first contact position travels over such distance, and it may, for example, be set to approximately 2 cm. When the contact position cannot be sensed (step S180; Yes), the computer system 140 hides the position specification cursor (step S190), and the processing ends without acquiring the specified position. On the other hand, when, in step S180, the contact position can be sensed (step S180; No), the processing returns to step S120. Therefore, the computer system 140 repeatedly performs steps S120 and S180 until the contact position reaches the predetermined distance, as long as the contact position can be sensed.

Meanwhile, when, in step S120, the distance from the first contact position to the contact position has reached the predetermined distance (step S120; Yes), the computer system 140 changes the display appearance of the position specification cursor (step S130). By changing the display appearance of the position specification cursor, the user can be notified of the fact that the travel amount from the first contact position to the contact position has reached the predetermined distance. As described in the following, from the time when the distance from the first contact position to the contact position has reached the predetermined distance, the computer system 140 can acquire the specified position by sensing a predetermined position specification determination operation. Here, the display appearance of the position specification cursor when the travel amount from the first contact position to the contact position has not reached the predetermined distance will be referred to as a “non-effective state” and the display appearance of the position specification cursor from the time when the travel amount from the first contact position to the contact position has reached the predetermined distance will be referred to as an “effective state.”

Subsequently, in response to a further movement of the contact position to be sensed, the computer system 140 moves the position specification cursor by following the contact position such that the relative positional relationship between the position specification cursor and the contact position of the time when the distance from the first contact position to the contact position has reached the predetermined distance is maintained (step S140).

Subsequently, the computer system 140 determines whether the position specification determination operation is sensed (step S150). The “position specification determination operation” refers to a specific operation for causing the computer system 140 to acquire the position where the position specification cursor is displayed as the specified position. In the present example, the position specification determination operation refers to the operation of ending the contact (namely, the operation of lifting the finger that was touching the screen). When the position specification determination operation is not sensed (step S150; No), the computer system 140 returns the processing to step S140. Accordingly, the computer system 140 repeatedly performs steps S140 and S150 until the position specification determination operation is sensed, and continues to move the position specification cursor by following the contact position. On the other hand, when, in step S150, the position specification determination operation is sensed (S150; Yes), the computer system 140 acquires the position where the position specification cursor is displayed when the position specification determination operation is sensed as the specified position (step S160). Then, the computer system 140 performs processing (for example, displaying a mark at the specified position, searching for an edge in the periphery of the specified position, etc.) in response to the specified position in the first window W1 (step S170), and terminates the processing.

Next, a specific example of the position specification method according to the present embodiment will be described with reference to an example of the display screen.

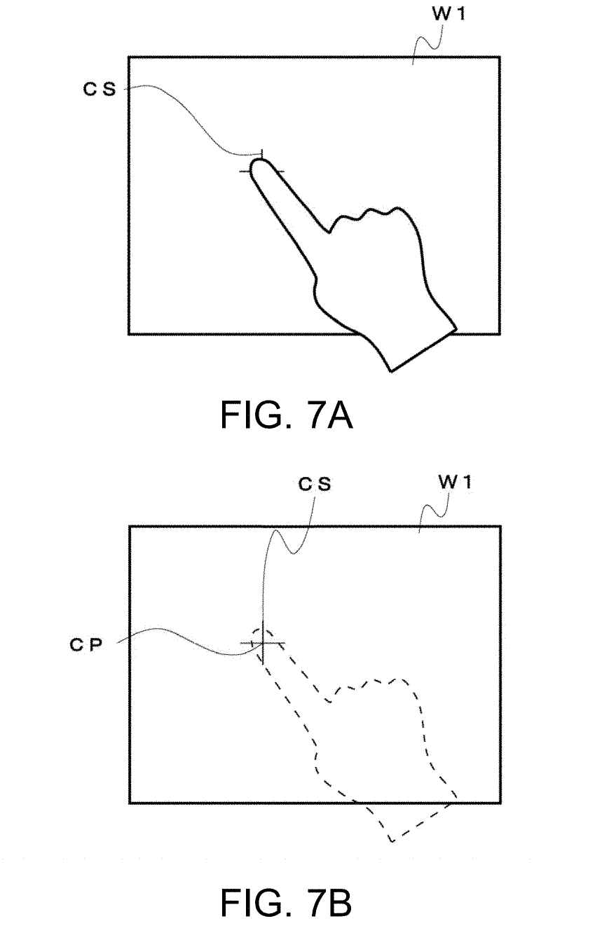

FIGS. 7A and 7B schematically show the state in which a screen (the first window W1) is touched with a finger. FIG. 7A shows the screen of the touch-sensitive panel display 144, which is seen by the user when the user touches the screen with his/her finger, and a hand performing the operation. FIG. 7B shows, along with a virtual line of the finger touching the screen, the display example of the screen when such screen is touched with the finger. The computer system 140 starts the position specification processing in response to the user touching the screen with his/her finger or a pen. The computer system 140 recognizes the center of gravity of the region where the touch is sensed as the initial contact position P1 and displays the position specification cursor CS on this initial contact position P1. In the present example, the position specification cursor CS is a cross mark that intersects at the initial contact position P1.

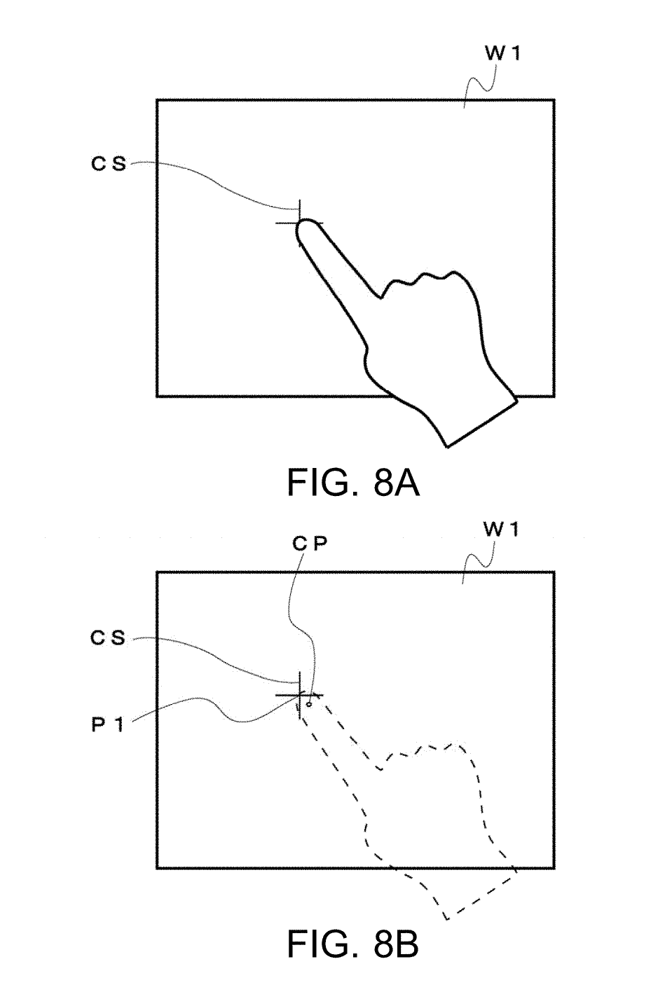

FIGS. 8A and 8B schematically show the state in which the contact position CP is slightly moved from the initial contact position P1. It should be noted that the distance from the initial contact position P1 to the contact position CP in this case is less than the predetermined distance. FIG. 8A shows the screen of the touch-sensitive panel display 144, which is seen by the user, and a hand performing the operation. FIG. 8B shows a display example of the screen, along with a virtual line of the finger touching the screen. While the distance from the initial contact position P1 to the current contact position CP is less than the predetermined distance, the computer system 140 continues to display the position specification cursor CS at the initial contact position P1 as shown in FIG. 8. It should be noted that when the computer system 140 can no longer sense the contact (namely, when the user lifts his/her finger from the screen) in the state shown in FIG. 5 or FIG. 8, the computer system 140 hides the position specification cursor CS and terminates the specified position processing (corresponding to step S190 in FIG. 6).

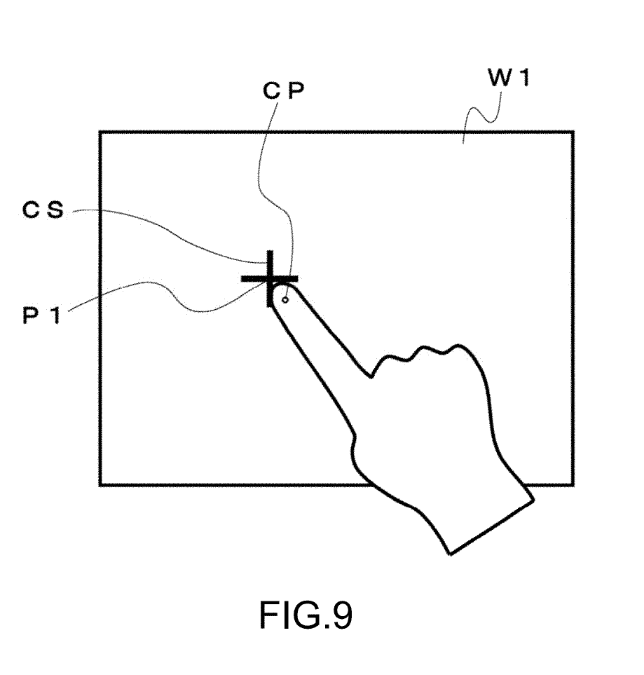

FIG. 9 shows a display example of the screen, along with a finger of a user, when the distance from the initial contact position P1 to the contact position CP has reached the predetermined distance. When the computer system 140 senses that the distance from the initial contact position P1 to the contact position CP has reached the predetermined distance, the computer system 140 changes the display appearance of the position specification cursor CS. Any display appearance may be used as the change example of the display appearance in such case, as long as the user can visually recognize the difference thereof before and after the change; however, as shown in FIG. 9, the line of the position specification cursor CS after the change may be made thicker than the corresponding line before the change or the saturation of the color thereof after the change may be made higher than the corresponding saturation before the change. The change is preferably made such that the visibility after the change is increased as compared to that before the change.

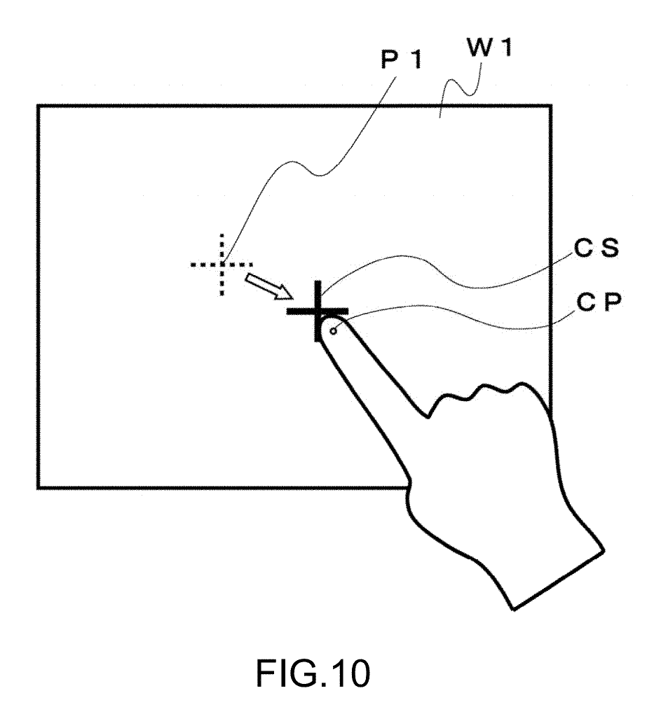

FIG. 10 shows a display example of the screen, along with a finger of a user, when the contact position CP is further moved from the state in FIG. 9. It should be noted that, in FIG. 10, the position specification cursor in the state in FIG. 9 is virtually shown with a dashed line. As shown in FIG. 10, the computer system 140 moves the position specification cursor CS by following the contact position CP such that the relative positional relationship between the position specification cursor CS and the contact position CP at the time when the distance from the first contact position P1 to the contact position CP has reached the predetermined distance is maintained. More specifically, as shown in FIG. 9, when the contact position CP is located at the lower right of the initial contact position P1 (i.e. when the position specification cursor CS is displayed at the upper left of the contact position CP) at the time when the distance from the initial contact position P1 to the contact position CP has reached the predetermined distance, if the contact position CP is further moved thereafter, the position specification cursor CS will always be displayed at the upper left of the contact position CP without being hidden by the finger or the like making contact with the contact position CP.

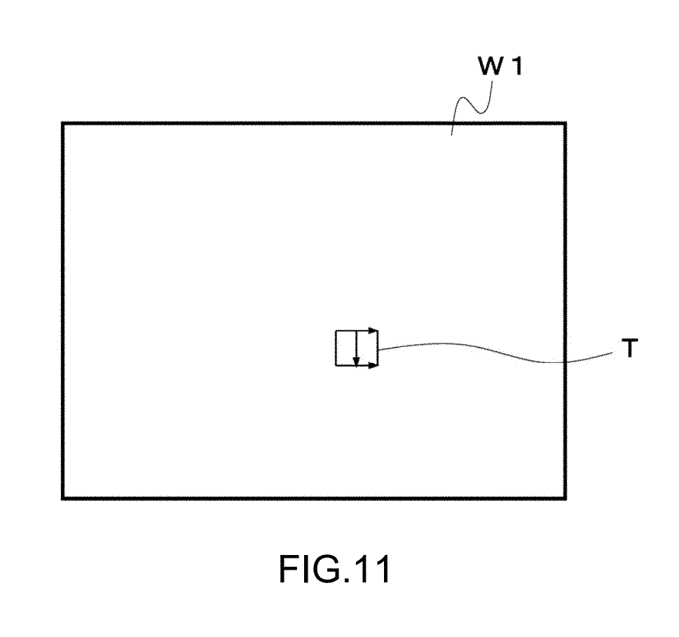

FIG. 11 shows a display example of the screen after sensing the position specification determination operation (i.e. termination of the contact in the present example). When the user moves the contact position CP such that the position specification cursor CS is displayed at a desired position and performs the position specification determination operation (i.e. when the user lifts his/her finger or the like from the screen), the computer system 140, in response thereto, acquires the position at which the position specification cursor CS is displayed at the time when the position specification determination operation is performed as the specified position, and also hides the position specification cursor CS. Then, the processing corresponding to the specified position (i.e. the processing of pasting and displaying the tool T at the specified position in the present example) is executed and the processing is terminated.

In this manner, the position specification method of the touch-sensitive panel display and the program thereof suitable for the operation at the touch-sensitive panel display 144 can be achieved. More specifically, the positions can be precisely specified with touch inputs by means of fingers or a stylus pen. In addition, unnecessary position specification processing due to unintentional contact can be prevented from being performed.

It should be noted that, in the above-described examples, the computer system 140 displays the position specification cursor CS at the initial contact position P1 when contact is sensed; however, the computer system 140 may also display the position specification cursor CS at a position according to the initial contact position P1, i.e. a position shifted from the initial contact position P1 in a predetermined direction and by a predetermined distance.

Moreover, the display appearances of the position specification cursor in the non-effective state and the effective state may be any display appearance, as long as the user can visually distinguish them.

### Editing of Edge Detection Tool

The application software for measurement applied to the image measurement apparatus 1 according to the present embodiment enables, as described hereinafter, editing such as adjustment of the position, size and direction of the edge detection tool pasted onto the image WG displayed in the first window W1, and deletion of the pasted tool. Hereinafter, a method of selecting a tool to be edited and an operation method of editing a tool will be described.

### Selection of a Tool to be Edited

The application software for measurement applied to the image measurement apparatus 1 according to the present embodiment can select the tool pasted onto the image WG displayed in the first window W1 by means of a method of directly touching and selecting the tool or by means of a method of operating the buttons arranged in a tool operation window and selecting the tool.

With the method of directly touching and selecting the tool, when a tool selection gesture in the first window W1 is detected, tools within a predetermined range in the periphery of the detected position of the tool selection gesture are searched, and a tool that is closest to the detection position of the tool selection gesture is placed into a selected status. It should be noted that, for example, any gestures including a tap, a double tap, a long tap, or the like, may be employed as the tool selection gestures.

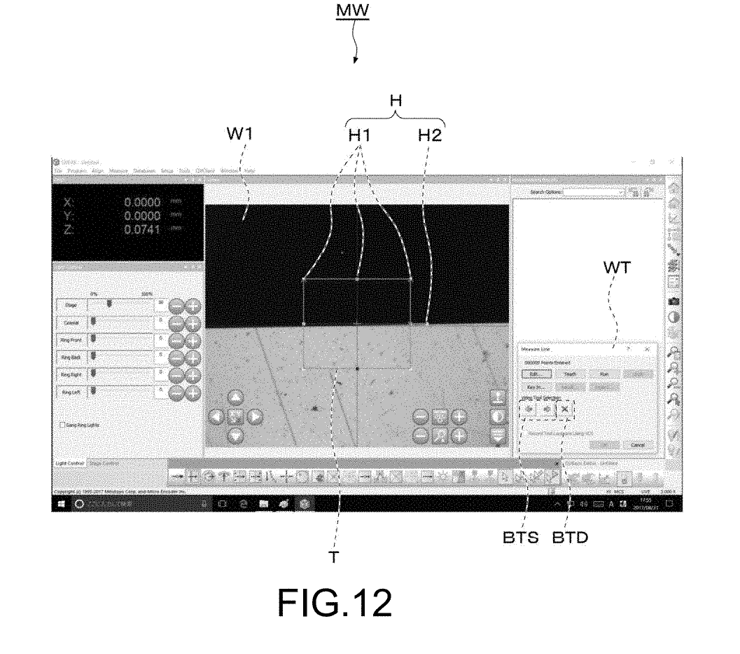

FIG. 12 shows an example of the display screen in which a rectangular edge detection tool is displayed in the first window W1 in an editable manner in the application software for measurement.

With the method of selecting the tool using the tool operation window WT, regarding the tools displayed in the first window W1, the tool to be placed into the selected status is sequentially switched in response to the tapping of the tool selection button BTS in the tool operation window WT shown in FIG. 12.

In any of the selection methods, the tool in the selected status is displayed with an appearance visually distinguishable from that of the tools in the non-selected status. For example, the tool may be made distinguishable by means of any form of expression, including a color change of the edge detection tool, the addition of the display of an editing handle, or the like. FIG. 12 is an example in which the tool in the selected status is made recognizable by adding the display of the graphic “□” showing editing handles H at the four corners of the rectangular edge detection tool.

### Editing Operation by Gestures

Under the situation where the edge detection tool is in the selected status, when a tool editing gesture, which is a gesture for editing the edge detection tool T, is touch input by a user at any position on the touch-sensitive panel display 144, the application software for measurement applied to the image measurement apparatus 1 according to the present embodiment performs the editing corresponding to the tool editing gesture on the tool in the selected status and reflects the same to the display of such tool in the touch-sensitive panel display 144.

Any gestures differing from the tool selection gestures may be employed as the tool editing gestures, including a pinch (an operation of decreasing the distance between two contact positions), an unpinch (an operation of increasing the distance between two contact positions), a rotation (an operation of changing the angle of a line connecting two contact positions), a swipe in the state where two points are simultaneously contacted (an operation of moving the contact position), or the like. However, it is preferable for the gestures matching the editing appearance of the edge detection tool T to be employed such that an intuitive input can be made. For example, the editing corresponding to each of the pinch and the unpinch may respectively be zooming-in and zooming-out, and the editing corresponding to the rotation may be rotation (i.e. directional rotation of the tool). The editing corresponding to the swipe conducted in the state where two points are simultaneously contacted may be parallel displacement in the swiped direction. It should be noted that when the tool is moved so as to be framed out of the first window W1 by means of a swipe conducted in the state where two points are simultaneously contacted, the tool may be regarded and processed as being deleted. Alternatively, when the tool reaches the frame of the first window W1 by means of a swipe conducted in the state where two points are simultaneously contacted, the tool may be made such that it no longer moves.

### Editing Operation by Editing Handle

The application software for measurement applied to the image measurement apparatus 1 according to the present embodiment displays an editing handle on the edge detection tool in the selected status. The editing handle H includes an expansion/contraction handle H1, a rotation handle H2, or the like. The expansion/contraction handle H1 is displayed at an expandable/contractable position of the tool as the graphic “□.” When this expansion/contraction handle is dragged, the size of the tool changes by following the drag. The rotation handle H2 is displayed at a position off the rotation center defined for every tool. When this rotation handle H2 is dragged, the direction of the tool changes by following the drag.

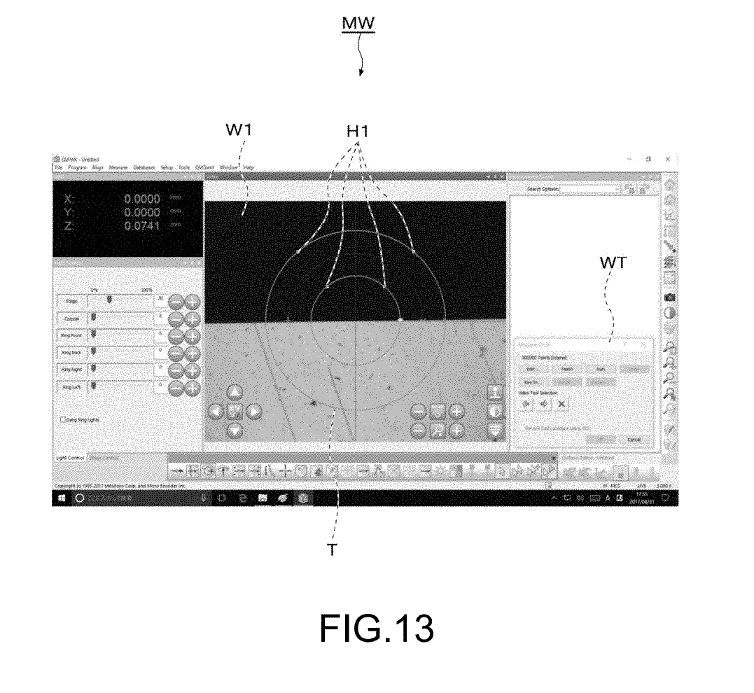

As a specific example, in the case of a rectangular tool, the expansion/contraction handles H1 are displayed at the four corners and at the center of each side of the tool T as shown in FIG. 12. The rotation handle H2 is displayed at an end of the line extending out from the middle of one side of the tool T. In the case of a circular tool for detecting a circular edge, the expansion/contraction handles H1 are displayed for each of the inner circle and outer circle defining the range in which the edge search is conducted as shown in FIG. 13. With the circular tool, the rotation handle is not displayed since the rotation thereof makes no sense.

It should be noted that when the size of the tool in the selected status is smaller than the predetermined threshold, an editing handle may be displayed at an end of the line extending out from the position where the editing handle H is usually displayed. In this way, a decrease in the touch input operability due to the editing handles H clustering together can be prevented.

Alternatively, when the size of the tool T is smaller than the predetermined threshold, a decrease in the operability may be prevented by hiding handles H that are redundant in terms of functions. For example, with the rectangular tool T shown in FIG. 12, eight expansion/contraction handles H1 are arranged (at the respective apexes and centers of the respective sides of the rectangular); however, when the size of the tool T becomes smaller than the predetermined threshold, the top right and bottom left handles may be kept and other handles may be hidden. In this way, despite the fact that the degree of freedom of operability may be decreased, the problem of the user erroneously grasping the unintended handle and operating the same may be reduced.

### Deletion of Edge Detection Tool

The application software for measurement applied to the image measurement apparatus 1 according to the present embodiment enables deletion of the tool that is in the selected status by means of a deletion method through a direct touch input or a deletion method through operating the buttons arranged on the tool operation window. With the deletion method through a direct touch input, when the tool in the selected status is dragged so as to be framed out of the first window W1, such tool is deleted. With the deletion method using the tool operation window WT, in response to the tool deletion button BTD in the tool operation window WT being tapped, the tool that is in the selected status at that time is then deleted.

What is claimed is:

1. An image measurement apparatus that images an object to be measured, and measures dimensions and shape of the object to be measured based on an image of the object to be measured displayed on the touch-sensitive panel display, comprising:
an controller that identifies a command corresponding to a gesture contact-input with respect to the touch-sensitive panel display from a signal output from the touch-sensitive panel display in response to the gesture, and executes the command with respect to a part in the image measurement apparatus, the part being the target of the execution of such command,
wherein the gesture is a gesture performed in the state in which the simultaneous touch is made at two or more points.

2. The image measurement apparatus according to claim 1, wherein the command is a command that causes a physical movement of parts of the image measurement apparatus.

3. The image measurement apparatus according to claim 2, wherein the gesture performed in the state in which the simultaneous touch is made at two or more points is a tap, a double tap, a long tap, a flick, a swipe, a drag, or a rotation.

4. A non-transitory computer readable medium storing a program causing a computer to function as the controller of the image measurement apparatus according to of claim 1.
